(19) United States
(12) Patent Application Publication
(10) Pub. No.: US 2008/0196228 A1
(43) Pub. Date: Aug. 21, 2008

(54) Anti-Tamper Ring Extraction Tool

(76) Inventor: Clive Graham Angel, Royston Herts (GB)

Correspondence Address: Levy & Grandinetti, 1725 K Street, N.W., Suite 408, Washington, DC, 20006-1419, US

(21) Appl. No.: 11/596,983

(22) PCT Filed: May 20, 2005
(86) PCT No.: PCT/IB2005/001377

§ 371 Date: Dec. 10, 2007

(30) Foreign Application Priority Data
May 20, 2004 (GB) 041289.2

(51) Int. Cl. B23P 19/04

(52) U.S. Cl. 29/221.6

(57) ABSTRACT

There is disclosed a tool for extracting an anti-tamper ring (24) from a valve assembly (16). The tool has four claws (50) spaced about the anti-tamper ring and each claw has leading and trailing claw tips (54, 56). An actuating mechanism moveably supports the claws for movement from a first position through a third position. In the first position the claws are adapted to have at least one claw tip resting on the anti-tamper ring. In the second position the claws are adapted to have the claw tips moved readily inwards towards the axis of the valve assembly and vertically upward relative to the first position so as to engage and lift the anti-tamper ring from the valve assembly. In the third position, the claws have the claw tips moved radially outward relative to the second position to release the anti-tamper ring from the claws.

### FIELD OF THE INVENTION

The present invention relates to an anti-tamper ring extraction tool for removing an anti-tamper ring from a valve assembly of an alcohol beverage container.

### BACKGROUND OF THE INVENTION

It is known to contain alcohol and beer in a container or a keg. In the case of a beer keg, pressure is applied to a beer containing bag housed within the keg to dispense beer the through a valve body assembly from the bag contained in the keg.

It is known to utilize an anti-tamper ring to prevent removal of the valve body assembly from the keg or to provide a visual indication that someone has tampered with the valve body assembly. The anti-tamper ring is usually seated around the outside of the valve body assembly and covers the valve body assembly and keg shoulder surrounding the valve body assembly. Further, the anti-tamper ring has been used to close a relief airway through the valve body assembly. When the anti-tamper ring is displaced from the relief airway or removed from the container, pressurized air between the bag and the keg inner liner wall safely bleeds through the relief airway.

By its very purpose, the anti-tamper ring is not easy to remove from the keg and valve body assembly. However, the anti-tamper ring needs to be removed when the keg is recycled for refilling. Once the anti-tamper ring is removed, the valve body assembly and the bag can be removed from the keg. Then, the bag is disposed with. The valve body assembly and the keg are cleaned and re-used. During this procedure, it is important that the valve body assembly not be damaged so that this part can be recycled. Accordingly, there is a need to provide a mechanism for removing an anti-tamper ring from the valve body assembly and the keg during recycling that is not subject to damaging the valve body assembly.

### SUMMARY OF THE INVENTION

The present invention relates to a tool for extracting an anti-tamper ring from a valve assembly having an axis. The tool has a plurality of claws that are adapted to be axially spaced about the axis. Each of the claws has at least one claw tip. An actuating mechanism moveably supports the claws for movement from at least a first to a second position. The claws in the first position are adapted to have at least one claw tip resting on the anti-tamper ring. The claws when moved into the second position are adapted to have the at least one claw tip move radially inward towards the axis of the valve assembly and vertically upward relative to the first position to engage and lift the anti-tamper ring from the valve assembly.

It should be understood that in the practice of the present invention at least two claws are required in order to provide proper leverage to pull or extract the anti-tamper ring from the valve assembly. Alternatively, three claws could be spaced at equal angles axially about the axis of the valve body assembly. In the preferred construction, four claws are utilized spaced equally around the valve body assembly at intervals of 90 degrees.

In accordance with the present invention, it is further contemplated that the actuating mechanism may be adapted to move the claws from the second position into a third position. In the third position, the at least one claw tip is moved radially outward relative to the second position so as to release the anti-tamper ring from the claws.

In the preferred construction, the claws have a leading claw tip and a trailing claw tip radially offset from each other. At least the leading claw tip rests on the anti-tamper ring when in the first position. When in the second position, the leading claw tip pierces the anti-tamper ring and the trailing claw tip at least engages the anti-tamper ring.

In the preferred construction, it is envisaged that the actuating mechanism comprises a cross beam support may be moveable horizontally in downward and upward strokes. The cross beam support supports four link arms each having a first link end portion that is pivotally connected a beam end portion of the cross beam support. Each of the four link arms has a second link end portion that is pivotally connected to a first claw end portion of the claws. Each of the claws has a mid pivot point about which the claw tips rotate to bring the claws into the first position as a cross beam support moves in a downward stroke. The claws are brought into a second position as the cross beam support moves in an upward stroke. It is further envisaged that the claws may be moved vertically relative to the cross beam support to effect movement of the claws from the second position to the third position. To effect this movement it is envisaged that additional means in the form of a cylinder actuated member may be attached to the mid pivot point to move the claws from the second position to the third position.

### BRIEF DESCRIPTION OF THE DRAWINGS

For a better understanding of the nature and objects of the present invention reference may be had to the accompanying diagrammatic drawing in which:

FIG. 1 is a split sectional view of anti-tamper ring extraction tool of the present invention showing the claws of the tool in two positions.

### DETAILED DESCRIPTION OF THE INVENTION

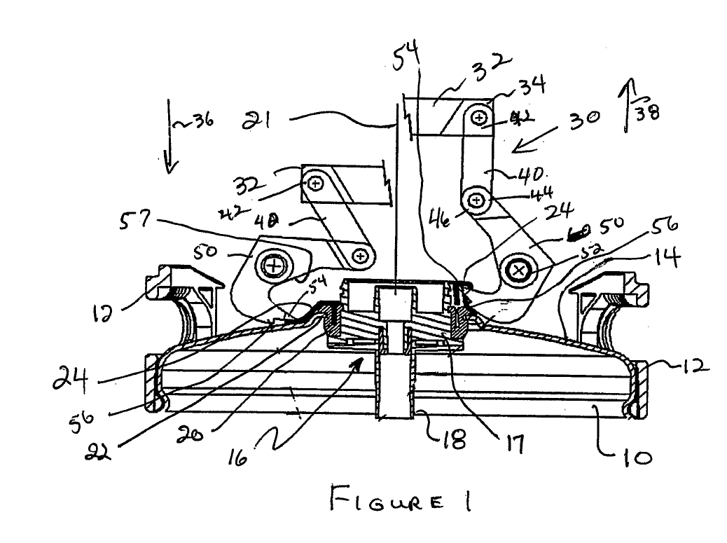

Referring to FIG. 1 there is shown an upper portion of an alcohol container or beer keg 10 having a chime 12 attached thereto. The beer keg 10 has a top wall 14. The top wall 14 has a central opening for receiving a valve body assembly 16.

The valve body assembly 16 has a hub 17 to which is connected a central spear 18 that extends into a bag (not shown). Alcohol or beer passes through a valve (not shown) in the hub 17 and through the spear 18 into and out of the keg 10. The hub 17 of the valve body assembly 16 further includes additional valves (not shown) used to pressurize the bag and the inside of the keg 10. The valve assembly 16 is shown oriented along a vertical extending axis 21.

The valve body assembly 16 has a bung 20 that interconnects the hub 17 with the edge 22 of the central opening of the top surface 14 of the keg 10.

Referring to the left side of FIG. 1, an anti-tamper ring 24 is shown mounted to the left side of the valve body assembly 16. Anti-tamper ring 24 is seated position with the valve body assembly 16. In this seated position, the anti-tamper ring 24 covers a portion of the top keg surface 14 and part of the valve body assembly 16.

It should be understood that FIG. 1 illustrates the anti-tamper ring 24 in its seated position on the left side of FIG. 1 and shows the anti-tamper ring 24 extracted from the valve body assembly 16 on the right side of FIG. 1. This split perspective view is utilized to illustrate both seating and extraction of the anti-tamper ring 24. In practice, the anti-tamper ring 24 is extracted at least substantially uniformly from the valve body assembly 16.

Referring to FIG. 1 there is shown a tool 30 for the removal of the anti-tamper ring 24 from the valve body assembly 16. The tool 30 comprises a pair of cross beam supports 32, extending orthogonally relative to each other and intersecting at a midpoint. Only one of the cross beam supports 32 is shown in FIG. 1. It should be understood that in practice the left hand and right hand sides of FIG. 1 of the cross beam support 32 are in fact one beam shown at two different positions. The cross beam support 32 has four beam end portions 34 of which only 2 are shown in FIG. 1. The cross beam 32 is moveable in a horizontal downward stroke indicated by arrow 36 and an upward horizontal stroke indicated by arrow 38.

The extraction tool further includes four link arms 40 which are pivotally connected at a first link end portion 42 to a corresponding first beam end portion 34. Each of the four link arms 40 has a second link end portion 44 which is pivotally connected with a claw end portion 46 of claws 50. Each of the claws 50 has a mid pivot point 52 and a pair of claw tips 54 and 56. The claws 50 are shaped with a concave-like surface 57 that faces towards axis 21 and extends between claw end portion 46 and claw tip 54.

In accordance with the present invention, the claws 50 are adapted to be axially spaced about axis 21. A tool actuating mechanism comprising the cross beams 34 and the four link arms 40 together with appropriate hydraulic cylinders (not shown) connected to the cross beam and to the mid pivot points 52 movably support the claws 50 between at least a first position shown on the left of FIG. 1 and a second position on the right of FIG. 1.

In the first position shown on the right of FIG. 1, the claws 50 are adapted to have the leading claw tip 54 resting on top of the anti-tamper ring 24. A trailing claw tip 56 is shown radially displaced outward from claw tip 54 and is supported above and in non-contacting relation with the top surface of the keg 14. When the cross beam supports 32 are moved in an upward stroke indicated by arrow 38, intermediate link arm 40 pivots relative to the cross beam member 32 causing the claw 50 to pivot about its mid pivot point 52 so that the claw tips 54 and 56 move radially inwards towards the axis 21 of the valve body assembly 16. Also with this pivoting movement, the claw tips 54 and 56 move vertically upward relative to the first position shown on the left of the drawing so as to engage and lift the anti-tamper ring 24 from the valve assembly 16. In the second position shown in the right of FIG. 1, the leading claw tip 54 has pierced the anti-tamper ring 24. The trailing tip 56 is engages and grasps the anti-tamper ring 24.

The upward stroke, as indicated by arrow 38, of the actuating mechanism continues until the anti-tamper ring 24 clears the top portion of the valve body assembly 16. At this time, the cross beam 32 stops its upward motion and an actuating piston cylinder (not shown) connected to the mid point 52 of the claw 50 continues to raise the claw 50. As a result of this, the claw 50 moves into a position relative to the cross beam 32 similar to that shown on the left hand side of FIG. 1. In other words, the cross beam 32 is positioned substantially at its location shown on the right hand side of FIG. 1 with the link 40 and the claw 50 in a position shown similar to that on the right hand side of FIG. 1. When moving from the second position to the third position the claws 50 rotate about pivot points 52 radially outward so that the claw tips 54 and 56 move radially outward relative to the positions shown in FIG. 2 to thereby release the anti-tamper ring 24 from the claws 50. Now, the tool 30 is ready to move in a downward stroke 36 once a keg 10 has been positioned beneath the tool 30 having an anti-tamper ring 24 to be removed.

The use of the tool 30 of the present invention allows for the simple extraction of an anti-tamper ring 24 normally locked in place with the valve body assembly 16. The tool 30 effectively extracts the anti-tamper ring 24, does not come into contact with the top surface 14 of the keg 10 and does not come into direct contact with the valve body assembly 16. Consequently, the tool does not damage the valve body assembly 16 nor mar the top surface 14 of the keg 10 during anti-tamper ring extraction.

1. A tool for extracting an anti-tamper ring from a valve assembly having a central axis and assembled to a container, the tool comprising:
a plurality of claws axially spaced about the axis, each of the claws having at least one claw tip;
an actuating mechanism for movably supporting the claws for movement from at least a first position to a second position;
wherein the claws in the first position have at least one claw tip resting on the anti-tamper ring; and
wherein the claws in the second position have at least one claw tip moved radially inward towards the axis of the valve assembly and vertically upward relative to the first position to engage and lift the anti-tamper ring from the valve assembly.

2. The tool of claim 1 wherein the actuating mechanism moves the claws from the second position to a third position, wherein the claws in the third position have the at least one claw tip moved radially outward relative to the second position to release the anti-tamper ring from the claw.

3. The tool of claim 1 wherein each of the claws has a leading claw tip and a trailing claw tip radially offset from each other, at least the leading claw tip resting on the anti-tamper ring when in the first position, and when in the second position, the leading claw tip piercing the anti-tamper ring and the trailing claw tip at least engaging the anti-tamper ring.

4. The tool of claim 1 wherein the actuating mechanism supports four claws and comprises:
a cross beam support movable horizontally in downward strokes and upward strokes;
four link arms each having a first link end portion pivotally connected with a beam end portion of the cross beam support, and each of the four link arms having a second link end portion pivotally connected with a first claw end portion of the claws; and,
each of the claws having a mid pivot point about which the at least one claw tip rotates bringing the claws into the first position as the cross beam support moves in the downward stroke and bringing the claws into the second position as the cross beam support moves in the upward stroke.

5. The tool of claim 3 wherein the actuating mechanism supports four claws and comprises:
a cross beam support movable horizontally in downward and upward strokes;
four link arms each having a first link end portion pivotally connected with a beam end portion of the cross beam support, and each of the four link arms having a second link end portion pivotally connected with a first claw end portion of the claws; and,
each of the claws having a mid pivot point about which the at least one claw tip rotates bringing the claws into the first position as the cross beam support moves in the downward stroke and bringing the claws into the second position as the cross beam support moves in the upward stroke.

6. The tool of claim 5 wherein each of the claws is vertically movable relative to the cross beam support to effect movement of the claws from the second position to the third position.

7. The tool of claim 1 including means for actuating the movement of the claws from the second position to the third position.

8. The tool of claim 2 wherein each of the claws has a leading claw tip and a trailing claw tip radially offset from each other, at least the leading claw tip resting on the anti-tamper ring when in the first position, and when in the second position, the leading claw tip piercing the anti-tamper ring and the trailing claw tip at least engaging the anti-tamper ring.

9. The tool of claim 2 wherein the actuating mechanism supports four claws and comprises:
a cross beam support movable horizontally in downward strokes and upward strokes;
four link arms each having a first link end portion pivotally connected with a beam end portion of the cross beam support, and each of the four link arms having a second link end portion pivotally connected with a first claw end portion of the claws; and,
each of the claws having a mid pivot point about which the at least one claw tip rotates bringing the claws into the first position as the cross beam support moves in the downward stroke and bringing the claws into the second position as the cross beam support moves in the upward stroke.
